(19) United States
(12) Patent Application Publication
(10) Pub. No.: US 2010/0186272 A1
(43) Pub. Date: Jul. 29, 2010

(54) METHOD AND DEVICE FOR DISPLAYING IMAGES

(76) Inventor: Philippe Aloïs Margueritte Marie André Ophoff, Kruibeke (BE)

Correspondence Address: KENYON & KENYON LLP, ONE BROADWAY, NEW YORK, NY, 10004, US

(21) Appl. No.: 12/160,557

(22) PCT Filed: Jan. 10, 2007
(86) PCT No.: PCT/BE07/00003

§ 371 Date: Mar. 24, 2010

(30) Foreign Application Priority Data
Jan. 10, 2006 (BE) 2006/0019

(51) Int. Cl. G09F 11/22

(52) U.S. Cl. 40/467; 40/463

(57) ABSTRACT

A method and a device are for displaying images. A chain of a determined number of images is provided in a housing. Images are displayed by being positioned in a display area. Images are displayed in a determined number of steps corresponding with the number of images. The control device switches the drive device on and off for the purpose of positioning and displaying one of the images. The method and device include calculation of the steps with a parameter determined by the movement of the chain from a position close to a start to a position close to an end of the chain.

### FIELD OF THE INVENTION

The present invention relates to a method for displaying images. The number of images to be displayed can vary. The method according to example embodiments of the present invention include providing a chain of a determined number of images, providing a display area for displaying one image at a time, and displaying the images by moving the chain in the display area and positioning the image in the display area. Displaying of the images may be repeated, e.g., by performing a determined number of steps, wherein the determined number of steps corresponds with the number of images in the chain. The present invention also relates to an image display device.

### BACKGROUND INFORMATION

It is known to display images. Such devices are used to display advertising. Use can be made of a light box. A number of images, posters or the like are joined to each other and thus form a chain of images. The images can be shown one after another. Various different connecting techniques can be used.

An image can be displayed to a public by moving the image into the display area, often a window in the housing, and freezing it there. After a determined time, which can be variable or fixed, the chain is moved further and the displayed image disappears from sight/the window and a new image, the subsequent image, is moved into the display area and held there. In this manner a number of different, or optionally the same, images of a chain of images can be displayed.

It is conventional for the images/posters to have a rectangular form. It is, however, characteristic for certain conventional scrolling mechanisms that the images do not have a rectangular form because the images are not cut at right angles. When the images are joined into a sequence of images for displaying, a sequence is formed which also includes images which are not fully at right angles to each other.

According to certain conventional systems, the images are provided with a marker, for instance a sticker, which is arranged on each image. The marker can be detected. A detecting device is present for this purpose. The detecting device is arranged in the display area and directed at the image which must be shown in the display area. While the chain of images moves, the detecting device scans the images until the marker is detected. Detection results in the movement being stopped. The sticker is arranged such that the image comes to a stop centrally in the display area. The marking positions the image in the display area.

A device is described in U.S. Patent Application Publication No. 2002/0018055 which positions posters in a display area. Two rolls are used to wind up and unwind a fixed carrier. The carrier has a known length. Posters which must be positioned in a display area can be arranged on the carrier. U.S. Patent Application Publication No. 2002/0018055 describes the use of markers on each arranged poster. The position of the markers can be read using sensors arranged in the display area.

The chain of images consists of a number of images. A chain of images may include a random number of images. The images can be replaced. Additional images can be placed later by incorporating them in the chain. The number of images is thus variable.

According to certain conventional systems, the arranging of the marker, sticker or magnetic strip takes place manually and is therefore labour-intensive. This often takes place when the images are replaced or added. In addition, it is possible for such a marker to become detached, particularly in a light box, wherein the increased temperature can result in glue coming loose.

### SUMMARY

Example embodiments of the present invention provide a method and device wherein the positioning is ensured at lower cost, particularly in the case of a chain of images where the total length of the chain is constantly changing.

The determined number of steps corresponding to the number of images in the chain of images may be calculated on the basis of a parameter related to a length of the chain. The parameter of the chain may be determined by the movement of the chain from a position close to a start of the chain to a position close to an end of the chain. A parameter can be obtained which is proportional to the length of the chain, wherein the length of the chain depends on the number of images included in the chain. The parameter depends on the number of images. The movement of the chain from a position close to the first end to a position close to the other end and the associated measurement may be a component of an initialization which may be performed after the method is started up, for instance after images have been changed. Various methods of determining a parameter complying with the functions may be applied.

The calculation of the number of images is not believed to be described in the prior art, e.g., U.S. Patent Application Publication No. 2002/0018055. In the prior art all images have a marker. This is visible when the image is displayed. Calculating the number of images is not important in the known prior art. In the context of the use of the fixed carrier the length of the chain is also always the same.

It is possible to compare the parameter to a number of predetermined values, for instance stored in a memory, whereby it is possible to establish how many images are included in the chain. Because the number of images can thus be determined by the initialization, it is possible to perform the method of displaying the images and to display the images in stepwise manner in the display area. The comparison of the parameter can take place through a comparison to a table of stored values.

The calculation of the number of steps may include comparing the determined parameter to a predetermined image length value, wherein the image length value is related to a length of a poster in the chain. The parameter is for instance divided by a second parameter which corresponds with a length of one image and which is for instance stored in a memory. This image length value can be predetermined.

The parameter related to the length of the chain of images can be determined by measuring the time required to move the whole chain of images through the display area. During the initialization the movement must be performed continuously, so not in stepwise manner. In addition, it is favourable that the drive used for the movement or scrolling of the chain of images is substantially linear. When these requirements have been met, the time can be used as parameter for determining the number of images in the chain.

It is noted that determining of the number of images can take place with a wide margin of error. The format of the display area may correspond with the size of the image. The image may fill the whole window.

One or more markings may be provided on the chain close to one of the ends or close to the ends of the chain, and the method further includes detecting the marking arranged on the chain. Detection of one marking close to both ends ensures that the chain at least moves between the markings. The markings may be arranged on the chain close to the ends.

The chain of images may be formed by two starting strips (leader and tale strip) and a number of images therebetween. The starting strip is connected to a roll onto which the chain can be wound. The starting strip may be longer than the display area. It is particularly possible with the starting strip to span the full distance between two rolls onto and from which the chain is wound and unwound.

One or both starting strips can be provided with one or more markings. The markings can be arranged once-only. Multiple guarantees can be given for forming of the connection. In contrast to the individual images, the starting strip is not replaced during the lifespan of the device for displaying the images. The marking can be connected in sure manner to the starting strip. One or more connecting techniques can be used. The arranging of the marking on the starting strips ensures that all images arranged between the markings are moved through the display area during the initialization.

The image length value may be obtained by detecting two markings on the chain, wherein the image length value is related to the length of the chain between these two markings. The image length value does not have to be hard stored in for instance a memory element but can be read from the chain at any random moment, for instance during an initialization. It is moreover possible that the electronic control circuit required for controlling the method is made independent of the size of the images, and thus that the control can be used for different devices.

For calculating the number of steps the control device detects the distance between the markings, and calculates therefrom the desired image length value, which corresponds with the format of the display area. The distance between the markings, which may also be arranged on the starting strip, corresponds for instance with a third or a quarter of the total image length. A standard or protocol can be selected for this purpose such that the control circuit can convert this detected distance to a value corresponding with the image length value. The image length value can then be compared to the parameter. In addition, the markings can be formed, or have measurable properties, such that the control device recognizes that these markings are intended for indicating the image length value, or at least a value corresponding therewith. In the case of optically detectable markings the marking itself can have a determined length as recognition for the control unit.

The length of the marking may itself be a measure for the image length value. Only one marking is necessary for the purpose of determining the image length value.

A position value may be assigned to the positions of the chain in the method, wherein the parameter is substantially equal to the difference between the position values in the markings. The movement of the chain through the display area acquires a positional lay-out which can be used to position the images in the display area. During initialization, in particular when the markings are used, the difference in position is used to calculate the number of steps, i.e. to determine the number of posters in the chain.

It is favourable that the calculation according to the method further includes subtracting from a determined parameter a predetermined compensation value related to the length of the chain between the marking on the starting strip and the first poster on the chain. It is known at which position the marking is arranged and where the first poster is arranged.

When the first marking on the starting strip is detected, the control device is able to determine the location of the first poster by the compensation factor. Determining the compensation factor can take place in a pre-initialization or can be hard stored, for instance in a memory device which is connected to the control device.

The foregoing may be applied by unwinding the chain of images from a roll and simultaneously winding the chain of images onto a second roll. A scroll principle is obtained. The first roll is used as storage and the second roll as receiver of the chain, and the images can be carried, scrolled, from the one roll to the other, wherein the display area is arranged between the rolls. The movement is also possible vice versa.

According to example embodiments, which can optionally be applied separately of the other aspects hereof, the measuring of a parameter related to the length of the chain is performed by starting the measurement and subsequently scrolling the chain from the lower roll to the upper roll. The measurement of parameters related to the chain of images takes place more precisely when the chain is wound onto the uppermost of two rolls. The chain being carried upward will be rolled up more tightly under the influence of the force of gravity. Rolling up of the chain in this manner can also be reproduced more consistently. The margin of error in the measurements can be reduced by 10% by measuring and rolling up as stated above.

The detection may include directing a field of vision of the detecting device at the roll and detecting the marking on the chain wound onto the roll. Detection of the marking is displaced out of the display area and does not disrupt the illumination of the display surface as in certain conventional systems. The direction of detection may be the same as the direction of movement of the chain through the display area.

The movement of the chain may be performed by a pulse motor, wherein the pulses generated by the motor are used, in particular counted, in order to determine the parameter. The pulses of the pulse motor, in particular the pulses generated by the pulse motor, are a measure for the position of the chain of images, and in particular the length of this chain of images. When it is detected during initialization that the movement from a first marking on a starting strip to another marking on another starting strip includes a determined number of pulses, this determined number of pulses is a measure for the number of images included in the chain, which can be converted to that determined number by comparison to for instance a table. A comparison can also be made to an image length value. expressed in pulses in order to calculate the number of steps.

It is further favourable that the calculation further includes dividing the parameter into a number of parts equal to the determined number of steps, wherein these parts have different sizes in each case. Account is taken of the circumstance that the pulse motor drives a roll onto which the chain of images is wound, wherein the rotation speed is not wholly proportional to the speed of movement of the chain since the radius of the roll plus the chain wound thereon increases/decreases. An increasingly decreasing number of pulses may correspond with a step for an image. This will be further illustrated in the figure description. Because the radius of the roll and wound chain of images becomes increasingly larger, it will be possible to place the image in the display area with a smaller number of pulses. The size of different parts can be calculated using a roll-up factor.

The calculation may include forming of parts, wherein the n^{th} part is calculated by multiplying the predetermined image length value by n*(l−m), wherein m is a predetermined roll-up factor related to the thickness of the chain when it is wound onto the roll. The size of a step expressed in for instance pulses becomes increasingly smaller, wherein the compensation by the roll-up factor is carried out by approximation by a linear function.

One marker or two markers may be arranged on at least one starting strip, wherein a parameter determined on the basis of the length of the marker or the distance between the markers is measured when this starting strip with the marker(s) is wound onto the roll. When the measurement takes place by a pulse counter, wherein the count depends on the rotation of the roll, the parameter measured with the pulse counter will be a measure for the arcuate angle defined with the length of the marker or the intermediate distance between the markers. Despite the fixed length of the marker or the fixed intermediate distance between markers this measured arcuate angle can vary due to the roll-up factor. This degree of variation can be used to calculate the roll-up factor more accurately. When a long chain of images is wound onto the roll, a shorter arcuate angle will be measured for the length of the marker than in the case where only a few images are rolled up. Because a large number of layers are wound onto the roll, the outer periphery of the roll will increase and the arcuate angle corresponding with the length will decrease. A marker or an intermediate distance between markers, which is related to the length of the images, is otherwise, e.g., arranged on the other starting strip.

Other variables which may influence the accuracy of the positioning, in particular the roll-up factor, are: stiffness of the material of the images, wind-up speed. By repeatedly carrying out the initial measurement of parameters a more accurate measurement and calculation can be made, wherein use may be made of averaging.

An image display device for displaying images includes a housing provided with a display area for displaying images, two substantially parallel rolls which are arranged in the housing and which are placed on either side of the display area, wherein a chain of images can be wound onto the rolls such that the images can be positioned in the display area, a drive device for driving the rolls, a control device coupled to the drive device for switching the drive device on and off for the purpose of positioning and displaying one of the images in the display area in a number of steps. The control device is adapted to determine a parameter which is related to the movement of the chain from a position close to a start to a position close to an end of the chain, and the control device is further adapted to calculate the number of steps on the basis of the determined parameter. A device is obtained wherein the control device is able to control the drive device, thus moves the chain of images from a position close to a start to a position close to an end thereof, and determines a parameter depending on the length of the chain, in particular the number of images in the chain, such that the number of steps can be calculated for positioning one of the images of the chain at a time in the display area. Once the images, for instance ten, have been included in the chain, these ten images will with correct operation have to be positioned and held in the display area for a determined period of time. In order to calculate the number of steps the control drives the drive to a location close to the start of the chain and then to a position close to the end of the chain. A parameter is determined which is related to the length of the chain and therefore to the number of images in the chain.

The parameter may be the time which is required to scroll from the start of the chain to the end of the chain. The scrolling must then take place substantially continuously at a substantially continuous speed. Comparison of the required time to a table of times stored in a memory device allows the control device to determine the number of steps with which the images must be placed in the display area.

A detecting device may be coupled to the control device for detecting a marker arranged on the chain. A marker arranged on the chain can be used for instance for the initialization of the invention. A detectable element, for instance with magnetic properties, can be used as marker, or an optically detectable device such as a strip, etc., can be used. The detecting device is arranged to detect the marker. It should be appreciated that different detecting devices and markers or markings can be used.

At least two markers may be arranged on the chain of images, in particular close to the ends of the chain, wherein the parameter is related to the length of the chain between the two detectable markers. The markings can be positioned outside the display area, i.e. outside the field of vision of the viewer. Not every poster or image is provided with such a marker. The marker may be arranged on a starting strip.

Connected to the control device may be a memory device for an image length value related to the image length of an image in the chain. The determined parameter related to the length of the chain of images from a position close to the first end to a position close to the second end can be compared to this value stored in the memory device, whereby it is possible to determine how many steps are necessary for positioning the respective images in the display area. The calculation can take place by a comparison, e.g., an operation comparable to a division.

The drive device may include a pulse motor. The control device may be adapted to count the pulses generated by the drive such that the position of the chain of images is associated with a determined number of pulses. The control device may further be adapted to calculate the parameter on the basis of the difference in pulse number at the respective positions, in particular at the positions of markers arranged on the chain. The use of the pulse motor provides in simple manner a counter for the position of the chain of images which is related to the drive. In order to compare the positions of the chain of images the number of pulses can be counted between a first position and a second position. This can be recorded by the control device. This pulse number is a measure for the length of the chain and is an example of a parameter. The image length value stored in the memory device may be a value based on the number of pulses.

The detecting device may be arranged in the vicinity of the roll and the detecting device may have a detection zone directed at the roll. The detecting device is removed from the display area and the display area is left clear, this being particularly suitable when a light box is used in the display area. Shadow effect of the detecting device is reduced considerably or eliminated completely. Detection on the roll has the additional advantage that it can take place outside the field of view of a user of the device.

The detecting device may be directed at the roll in a direction which is substantially parallel to the connecting line between the rolls. It is possible to give the display device smaller dimensions, and the detecting device can be readily incorporated in the housing.

The device may further include a chain of images which can be wound around the rolls and can be moved in the display area between the rolls. The images are placed respectively in the display area and the device is controlled in stepwise manner to display the respective images one at a time.

The chain of images may include two starting strips and a number of successively arranged images between the starting strips. The starting strips connect the images to the rolls. The starting strips are intended not to be replaced during the lifespan of the device. The starting strips can be provided with the markers, in particular the markers for measuring the length of the chain of images. In addition, the starting strips can be provided with a marker which is related to the length of an image or a size of the display area.

One starting strip may be provided with one marking or with two markings, the length respectively the intermediate distance of which can be detected by the detecting device, and wherein on the basis of the detection the control device is able to calculate or estimate an image length value from the detection. This measurement may take place close to a roll from which the chain is unwound.

The roll-up factor can be calculated or estimated on the basis of the detection. This measurement may take place close to a roll onto which the chain is wound.

Two markings may be arranged on one starting strip, wherein the intermediate space between the markings corresponds with for instance a third or a quarter of the image length. The image length and the intermediate space between the markings can be measured by counting the pulse number by the pulse motor.

A memory device for an offset value connected to the control means may be provided. The offset value allows the control device to compensate the position of a marking or the end of the chain relative to the first poster. When the position of the marker relative to a first poster is known, the control device can, when the first marker at the end of the chain is detected, drive the drive, in accordance with the offset value stored in the memory device, to a position in which the image, in particular the first image, is displayed in the display area. The number of steps can be performed from there. The measuring of a marking each time on the respective images is not necessary.

A second memory device for a compensation value may be connected to the control device. The control device is able to compensate the number of pulses generated by the pulse motor which is not linear with the length of the chain of images. The pulse motor rotates the roll, wherein the speed of movement of the chain depends on the radius of the roll and the chain of images wound thereon. When more images are wound onto the roll the radius is greater and the speed of movement will be greater, whereby the same movement of the image is obtained with a small number of pulses. The compensation value compensates for this.

A predetermined table can particularly be used for this purpose. A compensation mechanism may be used, for instance according to the algorithm wherein an image length step decreases in each case by a percentage of for instance one percent or a fixed value as the chain includes more images and these are wound onto the roll, this roll being driven with the pulse motor which generates the pulses to the control device.

Further features and aspects of example embodiments of the present invention are further discussed with reference to the accompanying drawings.

### BRIEF DESCRIPTION OF THE DRAWINGS

FIG. 1 is a perspective view of the device according to an example embodiment of the present invention.

FIG. 2 is a schematic cross-sectional view of an example embodiment of the present invention.

FIG. 3 is a schematic view of a chain of images.

FIG. 4 is a schematic view of a device according to an example embodiment of the present invention.

FIG. 5 shows an example embodiment.

### DETAILED DESCRIPTION

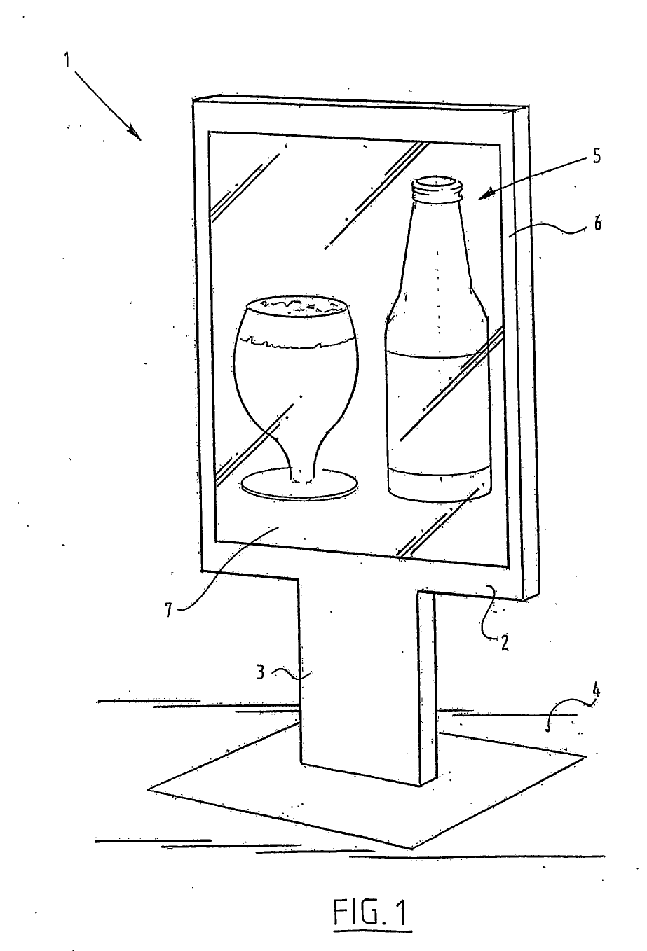

FIG. 1 shows a perspective view of an image display device 1 according to an example embodiment of the present invention. Device 1 can be placed at an outdoor location, in particular a viewing location. Different advertisements in the form of images can be shown to passers-by with the device.

Device 1 includes a housing 2 which is placed on a surface 4 by a base 3. Diverse other arrangements are possible. It is possible to place housing 2 on a support. It is possible to mount housing 2 on an upright wall. It should be apparent that diverse arrangements of the device are possible.

In an example embodiment various devices 1 can be placed adjacently of and above each other, wherein different images together form a complete image.

Housing 2 is provided with a window 5. In this example embodiment window 5 is a recess in housing 2. A transparent sheet, such as glass, is for instance placed in window 5. In the shown example embodiment window 5 has a frame 6 extending around window 5. Window 5 may be rectangular, although other arrangements are also possible.

Window 5 forms a display area in which an image 7, in this case a bottle and a glass, is shown. The bottle and the glass are shown to passers-by.

Diverse images can be shown successively in such a display area. The images are moved one after another in the display area and positioned in the display area, for instance for a predetermined time duration. The time duration may be programmable.

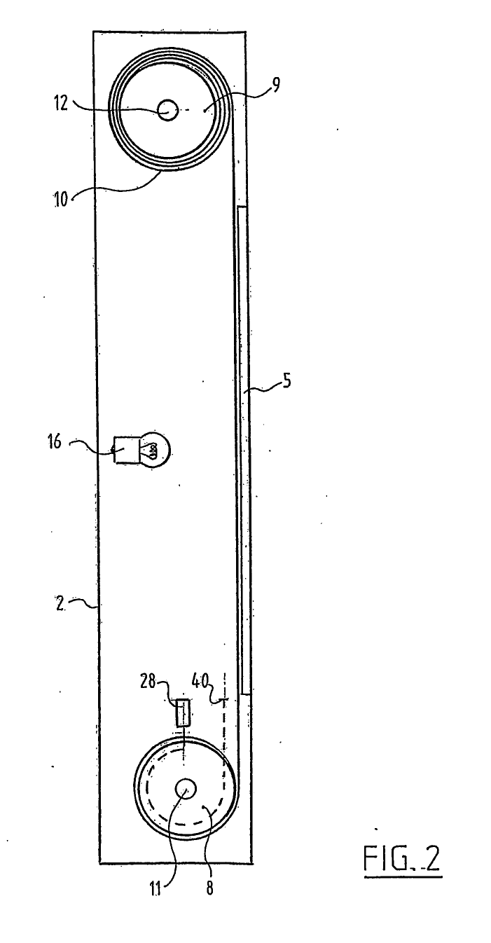

Two rolls 8,9 are accommodated in housing 2. The rolls are mounted, e.g., in a conventional manner in the housing. A chain 10 of a number of mutually connected images is wound around the roll. The rolls are placed on either side of window 5. The rolls are accommodated substantially parallel in the housing. Shafts 11,12 of rolls 8,9 extend at right angles to the plane of the cross-section of housing 2 according to FIG. 2.

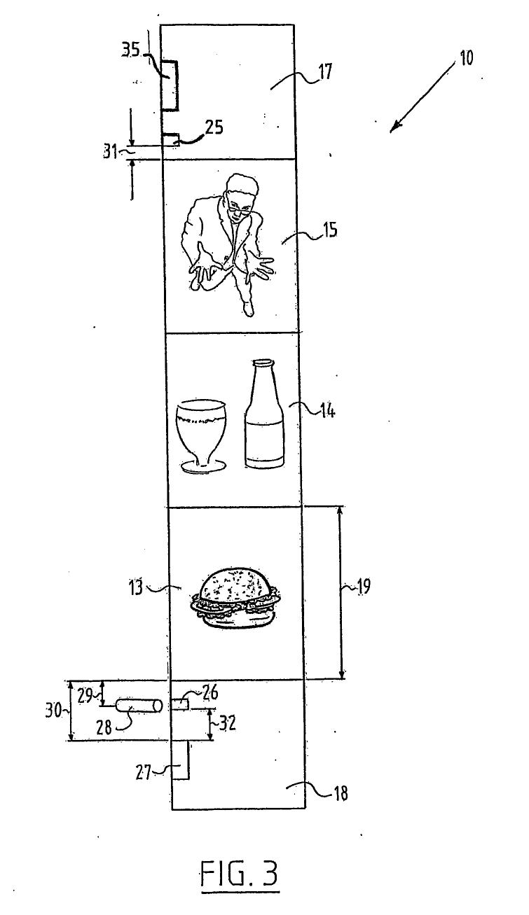

A chain 10 of images, FIG. 3 showing a chain having three images 13-15, is wound around rolls 8,9 and can be unwound from the one roll and simultaneously wound onto the other roll. Because rolls 8,9 are arranged at a distance from each other and window 5 is situated between rolls 8,9, a part of the chain is visible in window 5 and therefore positioned in a display area. A passer-by can see this image, as shown in FIG. 1.

FIG. 2 further shows schematically that a light source 16 is arranged in the housing. Light source 16 is situated behind the image of the chain of images which is situated in the display area. The displayed image will be illuminated for the passer-by.

According to example embodiments of the present invention the respective images of the chain are positioned one at a time in the display area.

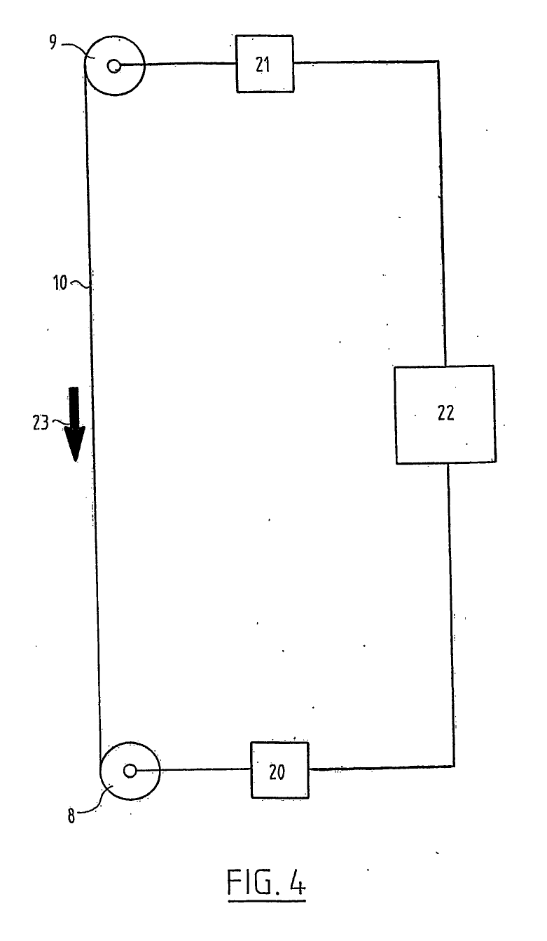

A drive 20,21 (shown schematically in FIG. 4) is coupled to one or both rolls. Various motors are suitable for the drive. The use of a drive is recommended. The rolls can be mutually coupled by belts. A transmission may be present.

The drive may be a DC motor with pulse counter. A brushless motor with a built-in pulse counter may be used. A stepping motor is also possible. The drive may be a pulse motor. When driven the pulse motor will generate a pulse corresponding with driving in a determined direction.

The drive or both drives are coupled to a control device 22. The control device is adapted to switch the drives on and off. The control device can switch drive 20 on, whereby roll 8 will rotate and chain 10 of images will move as according to arrow 23. Drive 21 may allow roll 9 to rotate freely.

The control device can count the pulses generated by the two drives 20,21 or by one of the drives. A lay-out is hereby obtained for the position of chain 10.

The drive can be switched on for a determined time. The time is then a scale for the position of the chain. This however makes demands on the continuity of the drive.

FIG. 3 shows schematically a chain 10 of images 13-15. In this example embodiment chain 10 further includes two starting strips 17/18. The starting strips 17, 18 are connected to respective rolls 8,9. As shown, the starting strips may be longer than the length of images 13-15. It is possible to span the distance between rolls 8 and 9 with a single starting strip. It is particularly possible to wind starting strip 17 onto roll 8 while starting strip 18 and the chain of images 13-15 are already wound onto roll 8. It is particularly possible to position marker 25 in front of detecting device 28, as will be described further hereinbelow.

The images each have substantially the same length 19. The length corresponds with the length of window 5 of the device. It is advantageous when the length of window 5 is smaller than the full length of the image. The connecting edges between the different images are then not visible during display.

The images 13-15 can be replaced. A technician is able to open housing 2, for instance by a key. One or a number of images in chain 10 can be replaced or a number of new images can be included in the chain. It is possible to increase the number of images in the chain, for instance to eight, ten or more images.

Images 13-15 can be connected to each other. A suitable releasable connection can be used for this purpose.

Once the technician has closed the housing again, it is not known what number of images/posters is present in the chain of images.

The technician can enter the number of images included in the chain into the control device via a suitable input device. This input is however susceptible to errors, especially when there is a large number of images.

The device and method may be able themselves to determine the number of images, and thereby the number of steps for showing these images, by calculation. In particular the location for positioning of each image in the display area can be calculated.

The chain of images can be moved by the drives to an end of this chain. The number of pulses required to move the chain to the other end can then be counted. This number of pulses can for instance be 120,000.

A value for image length 19 can be stored in a memory device. This value can for instance be 20,000 pulses.

The control device collects the data, in particular the number of pulses counted and the value from the memory. The number of images in the chain is six in this example embodiment without starting strips. The control stores this determined number of steps in a memory suitable for the purpose. When performing the method the control will position the images of the chain in the window in six steps. The end of the chain is then reached and the direction of movement is reversed in that the control will control the other drive to position the different images in the window/display area in six steps.

A marking 25 and/or marking 26 and/or marking 27 may be arranged on the chain, in particular on the starting strips. The markings are arranged close to the ends of the chain of images.

The markings can be detected by a detecting device 28 which is shown schematically. It can be an optical detector, or a magnetic or other suitable detecting device.

The markings may be fixed to the starting strips because they are not replaced by the technician. The starting strips may be present for the lifespan of the device and fixedly connected to the rolls.

When the detecting device detects marking 27 or marking 26, the chain can be moved until marking 25 is detected. The control has counted the pulses of the pulse motor and determines that there are 120,000 pulses for the purpose of carrying out the movement from the first marking to the second. The pulses are a parameter which is related to the length of the chain.

Because markings 25, 26/27 are not arranged immediately adjacently of the first images a length of the chain is present. Length 29/length 30 together with length 31 can be measured during a pre-initialization. It can be determined that length 29 corresponds with 11,000 pulses and length 31 with 9,000. The length between markings 26 and 25 is then equal to the length between the markings and the first images of the sequence of images, and the length of the number of images. The numbers mentioned are examples. The drawing according to FIG. 3 is not drawn to scale.

During the measurement of the number of pulses between markings 25/26 account must be taken of the additional number of pulses counted for the intermediate space.

In a count of 120,000 pulses, 20,000 pulses are not the result of the length of the images but the result of the intermediate space. When the value for the image length is 20,000 it will be necessary in this exemplary embodiment to establish that five images are present in the chain of images.

The compensation resulting from the location of the markings can be designated as the offset value. The offset value expressed in pulses is stored in a memory device connected to the control.

Marking 27 extends over a greater length of the chain than marking 26. It is possible that the control can recognize the markings by counting the number of pulses which is detected by the marking. The control is able to distinguish the markings.

An intermediate space 32 is present between markings 26 and 27. The control can be programmed in accordance with a protocol, wherein this protocol indicates that a value corresponding with the image length is indicated between the two markings. The protocol can be stored in a memory device suitable for the purpose.

Distance 32 can be measured by the control by measuring the number of pulses necessary to move chain 10 along length 32. The control is able to count the number of pulses from the moment that marking 27 is no longer detected by sensor 28 up to the moment that marking 26 is detected.

The number of pulses counted between marking 26 and 27 is for instance 5,000. The protocol indicates that the number of pulses determined by the control is for instance equal to a quarter of the number of pulses corresponding with the image length, so in this case 20,000.

In this example embodiment the intermediate space 32 corresponds with a quarter of the image length 19 of images which can be included in chain 10.

The measured value or the calculated value for the image length can be stored in a memory and can be retrieved at the moment when the number of steps/number of images must be calculated. In addition, a volatile memory can be used for temporary storage of the number of pulses. This arrangement is recommended since during initialization the control executes the movement from marker 27 to marker 25, measures/calculates the number of pulses for an image length, and can also immediately measure the number of pulses for the intermediate space between the markings close to the ends of the chain and immediately carry out the necessary calculations for the number of pulses, wherein the value from the volatile memory corresponding with the image length can be used. The image length is then measured each time during initialization. It is an advantage that no permanent memory for the value is present.

A further advantage of the arrangement without storage of the image length is that the same control can be applied in different display devices with different window sizes/suitable for images of different dimensions. This limits the production cost for the control circuit.

Because the chain of images including the starting strips is wound around a roll 8,9, the movement of the chain is not linear in relation to the number of pulses counted.

This can be illustrated with reference to FIG. 2. Rotation of roll 9 through 360° will result in a movement of the chain over a greater distance than rotation of roll 8 through the same angle. This is the result of the greater radius of the roll with images of the chain of images wound thereon around roll 9.

This difference can be compensated by a roll-up factor. The roll-up factor can be stored in a memory device suitable for the purpose.

A simplified compensation algorithm may be used. It should be appreciated that other methods are possible. The foregoing is however simple and this compensation is sufficient.

A roll-up factor may be measured in a pre-initialization and stored in a memory device. The roll-up factor can for instance be 1%. This may result in the first image having a length from a starting strip which corresponds with a pulse number according to the image length, either obtained from a memory or measured by measuring intermediate space 32.

When it is calculated that the chain of images has at least a second image, the number of pulses corresponding with the movement of this image is reduced by 1%, to 19,800.

When it is calculated that the chain of images has at least a third image, the number of pulses corresponding with the movement of this image is reduced by another 1%, to 19,602. This calculation can be repeated in each case for the subsequent image.

Because the drive is connected to the roll around which the images are wound, the roll with chain will become increasingly thicker and the radius will increase, whereby a larger movement is carried out with the same rotation. An image of the same length is moved along the window with a smaller number of pulses.

The compensation according to this arrangement can be calculated in accordance with:

Pulse number=pulse number output values*(1−m)ⁿ,

wherein the pulse number output value is the value which is determined by measurement and which corresponds with an image length, wherein m is the roll-up factor and wherein the length is the length of the n^{th} image in the chain.

The pulse number for the n^{th} image may be calculated in accordance with

Pulse number=pulse number output values*(l−n*m), wherein the compensation is deemed a linear factor. The pulse number in this example decreases by 200 at a time.

In application illustrated in FIG. 3 the following example can be given which is illustrated with pulse number. The pulses are counted during an initialization.

Marking 27 is detected with detecting device 28. The control determines the detection and begins the pulse count from the moment that marking 27 is no longer detected during movement to the other end of the chain. Marking 27 is then located at pulse number=0.

Marking 26 is then detected, wherein the chain has moved through distance 32. 5,000 pulses for instance are counted. The control device is adapted to recognize that four times this detected number of pulses is equal to the pulse number corresponding with the image length.

The end of marking 26 is for instance located at pulse number 6,000.

The movement is then continued further. The detecting device will detect marking 25. When marking 25 is reached the total pulse number is for instance equal to 107,010. This number is a parameter corresponding with the length of the chain. As stated, the time can be used as parameter.

The starting strip compensation value 9,000 is retrieved from a memory device by the control device. This compensation value compensates for the intermediate space between markings 26 and 25 and the respective first images 13 and 15. The distance 29 according to FIG. 3 is for instance 7,000 pulses and distance 31 is for instance 2,000 pulses. In this exemplary embodiment the compensation value is subtracted from the total number of pulses. The length of the images in the chain of images is in this example therefore 98,010 pulses.

Since the value corresponding with the image length is 20,000, the control is able during division into the number of steps to use the following table for comparison of the counted number of pulses and the number of steps to be calculated:

| Steps | number of pulses |
|---|---|
| 1 | 15000-25000 |
| 2 | 34800-44800 |
| 3 | 54400-64400 |
| 4 | 73800-83800 |
| 5 | 93000-103000 |
| 6 | 112000-122000 |

There may be a considerable margin of error for determining the number of steps. A margin of error of +−5000 pulses is allowed in each case in the above.

Use is made in this example embodiment of the roll-up compensation by a linear factor. The first image is 20,000 pulses long, the second 19,800, the third 19,600 and so on.

The counted number of pulses for the length of images thus corresponds in this example with five images. The control infers this number of steps and, after initialization as performed above, will be able to display the images after the offset value has been retrieved from a memory.

The offset value is a value which indicates the pulse value at which the first image is positioned in the display area. The offset value can also be determined during a pre-initialization or can be determined in a continuously repeated pre-initialization.

Marking 26 may be placed in a favourable manner such that the lower image 13 is situated in the display area at the moment that detecting device 28 detects marking 26. Storage in a memory is then not necessary. An additional advantage of this positioning is that the exact and correct position of the lower image in the display area is guaranteed every time. Scrolling of the poster is re-initialized each time marking 26 is detected. In this example embodiment the detection of marking 26 is then a mandatory step of the method for showing the images, since scrolling takes place each time until the marking is detected. It is for instance determined that five posters are present in the roll. The five are first shown in the first direction 13,14,15) and then in the second direction (15,14,13). This cycle is repeated continuously, but not after marking 26 has been detected.

By moving in each case up to marking 26 the scrolling can be adjustably controlled. The movement is stopped only at the moment that detecting device 28 detects marking 26. During scrolling shifting can occur in the strip of images, for instance due to the connection of the images coming partially loose or due to non-rectangular posters (cut at right angles) in the roll of posters. Since movement takes place in each case until marking 26 is detected, the movement is started in each case from the same starting position. This results in a more reliable display of the posters in the display area.

The starting strip may be wound onto the roll, the detecting device may be located exactly at the end of marking 26 and the length 29 may be equal to the distance 40 indicated with broken lines in FIG. 2.

The offset value indicates the pulse number of the position of the chain/roll at which the first image 13 can be placed in the window/display area.

FIG. 2 shows detecting device 28. Broken lines indicate the field of vision of the, e.g., optical detecting device. A laser scanner in particular is used.

The detection zone/the field of vision of the detecting device is directed toward roll 8. The markings which are detected are situated on the chain of images/starting strip, in particular on a part of the chain which is already/still wound around roll 8. The detecting device is situated outside the field of vision of a passer-by and does not cast a shadow on the image located in the window.

The detecting device is arranged with a detection direction oriented substantially parallel to the plane between the rolls. In the shown example embodiment the detecting device is directed at the chain wound onto the roll, wherein the detection takes place while the chain is wound about 270° around the roll. This placing is advantageous for the dimensioning of the device.

A second marking 35 may also be arranged on starting strip 17 as shown in FIG. 3. It is particularly possible to measure the distance between markings 25 and 35 when the chain of images 13-15 and starting strip 18 are wrapped around roll 8. The arcuate distance measured with detecting device 28 is a dimension which is related to the roll-up factor. Despite the absolute distance between markers 25,35 being fixed, the arcuate angle and the corresponding number of measured pulses will decrease when a greater number of images 13-15 is wound onto roll 8.

The method may include arranging the images and subsequently performing the initialization. During the initialization the whole chain of images may be wound and unwound at least twice between the rolls. A more precise measuring can take place. Part of the play in the length of the chain is removed. Furthermore, the new images included in the chain are made less stiff. The length of chain is measured more precisely. The measurement may take place by winding the chain onto the upper roll. Winding onto the upper roll takes place more accurately due to the effect of gravity on the chain, whereby the chain is tightened more during the winding.

During the initialization phase of the scroller the whole roll may be run from start to finish. The following actions are taken, illustrated with reference to FIG. 3:

The distance between the long strip 35 and marker 25 of poster 17 is measured. This distance (L), reduced by an estimated linear offset parameter (K),is the estimated total length of all posters together. The length is designated as roll length M. It is therefore roughly the case that M=L−K.

The distance from long strip 32 to marker 26 of poster 18 is measured. The long strip is arranged such that this distance is roughly equal to a quarter of the poster length. By multiplying this distance by 4 the approximate poster length is therefore known. This approximate poster length is referred to as S.

Marker 26 of poster 18 is arranged such that detection of marker 26 corresponds with the fact that the correct position of lower poster 13 is located roughly in the display area. The origin of the coordinate system is determined.

By dividing the total roll length M by the approximate poster length S the number of posters on the roll can be determined (after rounding off to the closest natural number). This number is referred to as N.

Roll length M is determined almost exactly. S is only an approximation of the poster length. In order to know the exact poster length, M must be divided by N. This exact poster length is referred to as T. It is therefore the case that T=M/N.

After these actions the scroller is initialized. The overall length of the roll (M), the correct number of posters (N) and the length of the posters (T) are now known exactly. The scroller is ready for automatic scrolling.

After initialization the general scrolling takes place. Due to the preparatory work in the initialization phase the automatic scrolling has become exceptionally simple. The coordinate p is continuously sampled on the basis of the quadrature encoder. If Δ pulses are seen in during movement in downward direction, p is then increased by A p. If Δ pulses are seen during movement in upward direction, p is then reduced by Δ p.

Permanent P is calculated from p using the previously formulated formula for the coordinate transformation: P=p+P²/R.

If P is a whole multiple of poster length T, the module in firmware which is responsible for marker-free scrolling then requests the module which controls the movements to stop at that position.

Once the system has come to a standstill at a determined position, the overshoot can be measured. Suppose that the system wants to stop at position T (this is poster 17). In reality the system will have a little overshoot and stop at position T+ΔT when the roll is running downward, or at position T−ΔT when the roll is running upward. ΔT is the overshoot. A progressive average is tracked of the overshoot. The overshoot is tracked separately for the two directions of rotation. The value T may be overwritten again at each scroll so that the ΔT is as small as possible.

At each passage of poster 18 along the marker the origin is re-calibrated. If this is not done, a very gradual shift would take place which can already produce an error of a number of centimetres after several hours.

Measurements

| Position | # pulses |
|---|---|
| Poster 1 | 4278 |
| Poster 2 | 531358 |
| Poster 3 | 1062501 |
| Poster length = 4x intermediate | 531280 |
| distance | |
| Roll length | 1608841 |

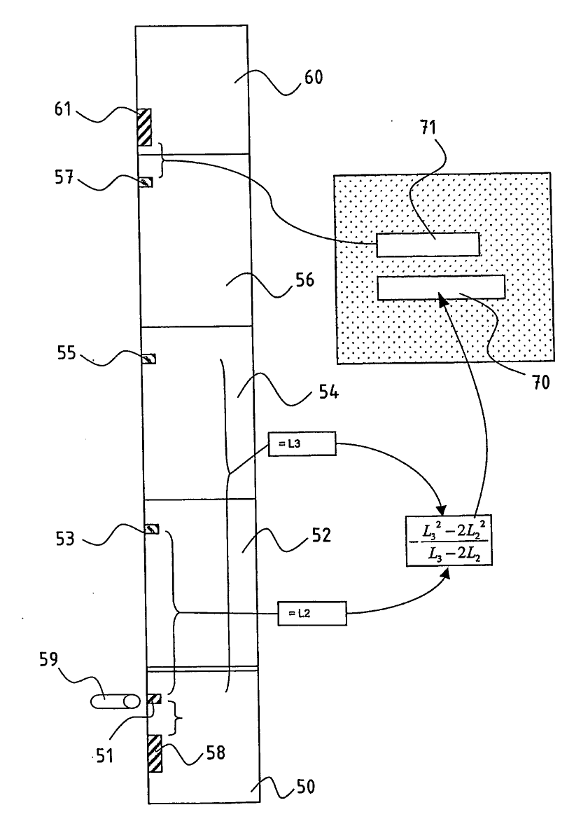

FIG. 5 shows an example embodiment. A number of virtual sensors are shown. The strip of images begins with a starting strip 50 which is provided with a marker 51. A virtual marker 53 is indicated on a subsequent poster 52. A virtual marker 55 is indicated on second poster 54. A virtual marker 57 is indicated on third poster 56. The markers are indicated by way of illustration and are not actual markers in this example embodiment.

FIG. 5 shows a calculation of the roll-up parameter 70. The parameter is given by a formula as indicated in FIG. 5, which depends on the length L2, i.e. the length between marker 51 and virtual marker 53 and being dependent on L3, this being the distance between marker 51 and virtual marker 55.

Detecting device 59 (sensor) measures the distance between a small strip 51 and long strip 58 on the lower starting strip, this distance corresponding with about a quarter the poster length. In addition, the flash parameters, i.e. roll-up 70 and offset 71, are determined. These will differ for each different chain configuration.

The L3 may be determined during a pre-initialization. The L3 is programmed in the firmware. L3 may be determined on the basis of measuring the roll length.

It is further noted that the wind-up properties of the posters on the lower roll are inherently inconsistent. The difference in roll diameter between two similar runs is large enough to have a negative effect on the positioning. An accuracy of 0.15% is desired so as to have an accuracy of 1 cm on a roll of four posters of a length of 170 cm. All other elements in the system achieve this accuracy. The pulse counter is sufficiently accurate, as is the motor transmission and the pulse counter input of the EM7, and firmware has already switched to 64-bit calculations in order to achieve this accuracy. However, the physical wind-up properties of the posters have an inherent inaccuracy of 2% (in unidirectional runs) to 7% (in runs in different directions). Over time these wind-up properties will also change due to the paper acquiring a form and reduction in the stiffness of the paper.

Long and short strips may be arranged on the upper and lower starting strip (see FIG. 3). According to FIG. 3 the upper starting strip has a short and a long strip. The upper and lower starting strips are thus symmetrically identical. The roll-up factor and the offset are determined more accurately. During initialization the upper starting strip is moved past the detecting device. The device can be artificially re-initialized on a regular basis at a determined point in time.

A second sensor may be added. An additional detecting device is added. In this manner the upper starting strip 17 can also be used as reference point during each cycle. The inherent inaccuracy of the winding up of the chain (number of pulses relative to the roll diameter) is reduced considerably. During each cycle a revision of the roll-up and of the offset is carried out. An additional advantage is that it is not necessary here to repeatedly set starting parameters. Roll-up and offset can be determined automatically.

This example embodiment is symmetrically identical. Not only is the display of the first poster, for instance first poster 52, ensured, but also the display of the final poster 54 at the correct position. In the first poster the short marker 51 is situated just in front of the sensor. It is precisely then that it is certain that poster 52 is displayed in the display area. When starting strip 60 with short marker 61 is moved such that short marker 61 is detected by the additional second detecting device, this is then precisely the position at which it is certain poster 54 is displayed in the display area. The length (number of pulses, taking roll-up into account) between those two short markers is the roll length. This number is divided by four times the distance between short strip 51 and long strip 58. The number of posters is obtained.

1-17. (canceled)

18. A method for displaying images, comprising:
providing a chain of a predetermined number of images;
providing a display area for displaying one image at a time;
displaying the images by moving the chain in the display area and positioning the image in the display area;
displaying the images of the chain in a predetermined number of steps corresponding with the predetermined number of images;
calculating the predetermined number of steps in accordance with a parameter related to a length of the chain; and
determining the parameter in accordance with the movement of the chain from a position close to a start of the chain to a position close to an end of the chain.

19. The method according to claim 18, further comprising:
providing markings on the chain close to the ends of the chain, the ends formed by two starting strips; and
detecting markings arranged on the starting strips.

20. The method according to claim 19, wherein one starting strip is provided with two markings, the method further comprising:
measuring a length between the two markings; and
determining a second parameter related to an image length value.

21. The method according to claim 18, wherein the calculating includes comparing the parameter to an image length value related to a length of the images on the chain.

22. The method according to claim 18, wherein the calculating includes subtracting from the parameter a predetermined compensation factor related to a length of the chain between the marking on a starting strip and the images on the chain.

23. The method according to claim 18, further comprising unwinding the chain of images from a roll and simultaneously winding the chain of images onto another roll.

24. The method according to claim 18, wherein the movement of the chain includes driving the movement with a pulse motor, and the parameter is determined in accordance with pulses of the pulse motor.

25. The method according to claim 18, wherein the calculating includes dividing the parameter into a number of parts equal to the predetermined number of steps, each part having a different size.

26. The method according to claim 25, wherein the calculating includes forming the parts, wherein an nth part is calculated by multiplying an image length value by n*(1−m), m representing a roll-up factor related to a thickness of the chain when wound onto a roll.

27. An image display device for displaying images, comprising:
a housing including a display area adapted to display images;
two substantially parallel rolls arranged in the housing and placed on either side of the display area, a chain of a number of images windable onto the rolls, each image positionable in the display area;
a drive device configured to drive the rolls; and
a control device coupled to the drive device and configured to switch the drive device on and off to position and display each image in the display area in a number of steps;
wherein the control device is configured to determine a parameter related to movement of the chain from a position close to a start to a position close to an end of the chain, and the control device is configured to calculate the number of steps corresponding with the number of images in accordance with the parameter.

28. The device according to claim 27, wherein the chain includes a number of images arranged between starting strips and markings are arranged on the starting strips, the image display device further comprising a detection device coupled to the control device and configured to detect the markings arranged on the starting strips, the parameter related to a length of the chain between two detectable markings.

29. The device according to claim 28, further comprising a memory device connected to the control device and configured to store an image length value related to the length of an image in the chain.

30. The device according to claim 29, wherein the drive device includes a pulse motor, the control device configured to count pulses, to associate a position of the chain of images with a determined number of pulses, and to calculate the parameter in accordance with a difference in pulse number at respective positions of the markers.

31. The device according to claim 30, wherein the detection device includes a detection zone directed at the roll.

32. The device according to claim 31, wherein the detection device is directed substantially parallel to a connecting line between the rolls.

33. The device according to claim 27, further comprising a memory device connected to the control device and configured to store an offset value related to the position of an image in the display area.

34. The device according to claim 27, further comprising a second memory device connected to the control device and configured to store a roll-up compensation value to compensate for a movement driven by a roll, wherein a radius of the roll varies.
